(19) United States
(12) Patent Application Publication
(10) Pub. No.: US 2024/0288294 A1
(43) Pub. Date: Aug. 29, 2024

(54) DUST FILTER FOR GAS METER

(71) Applicant: SAGEMCOM ENERGY & TELECOM SAS, BOIS-COLOMBES (FR)

(72) Inventor: Abbas SABRAOUI, BOIS-COLOMBES (FR)

(21) Appl. No.: 18/589,069

(22) Filed: Feb. 27, 2024

(30) Foreign Application Priority Data
Feb. 28, 2023 (FR) FR2301851

(51) Int. Cl. G01F 15/12; G01F 15/18

(52) U.S. Cl. CPC G01F 15/125; G01F 15/185

(57) ABSTRACT

Dust filter (40) for a gas meter (1) which comprises an inlet channel (41) and an outlet channel (42) passing through one same first plane (P1), the dust filter comprising a filtering medium (43) wherein a hole is made, a cross-section of the filtering medium and a cross-section of the hole, along a second plane (P2) perpendicular to a thickness of the filtering medium, having for shapes, the shapes of a cross-section of the inlet channel and of the outlet channel along the first plane, the dust filter (40) thus being arranged such that, when it is installed in the meter (1), the gas, before entering into the measuring module, passes into the inlet channel through the filtering medium, and after exiting the measuring module, passes into the outlet channel through the hole.

The invention relates to the field of gas meters, and in particular, ultrasonic single-tube gas meters.

### BACKGROUND OF THE INVENTION

A gas meter very conventionally comprises a measuring module intended to measure a flow rate of the gas which circulates in the meter.

Yet, it is known that gases, the flow rate of which is sought to be measured by using such a meter, transport a significant quantity of various dust particles.

The measurements taken by the measuring module of a gas meter can be disrupted by the presence of these dust particles. It is, in particular, the case for ultrasonic measuring modules.

Thus, it occurs frequently, that dust particles are deposited on the ultrasonic transducers and on the walls of the measuring conduit wherein the gas circulates, and wherein the transducers emit the ultrasonic signals. This phenomenon has the effect of disrupting the operation of the measuring module and of affecting the accuracy of the metrological measurements. The measuring error resulting from the presence of dust can go up to 4 to 5%.

A solution of the prior art is known, which proposes, to overcome this problem, to integrate the measuring circuit in an enlarged chamber inside the meter, and to make the gas circulate in the enlarged chamber, before returning into the measuring conduit, by passing through a bent channel. Dust thus falls through gravity into a dust deposition zone, located in the enlarged chamber outside of the measuring conduit.

However, as the dust zone is very close to the inlet of the measuring conduit, light dust tends to be suctioned into the measuring conduit when the gas flow rate is high, and thus risks being deposited on the transducers, and therefore disrupting the flow rate measurements taken by the measuring module. This solution is therefore not satisfactory.

### AIM OF THE INVENTION

The invention aims to improve the accuracy of the gas flow rate measurements taken by a single-tube gas meter, the gas transporting dust particles.

### SUMMARY OF THE INVENTION

In view of achieving this aim, a dust filter is proposed, arranged to be installed in a single-tube gas meter which comprises a measuring module arranged to measure a flow rate of a gas, as well as an inlet channel which extends upstream from the measuring module and an outlet channel which extends downstream from the measuring module, the inlet channel and the outlet channel passing through one same first plane, the dust filter comprising a filtering medium wherein a hole is made, a cross-section of the filtering medium and a cross-section of the hole, along a second plane perpendicular to a thickness of the filtering medium, respectively having for shapes, a shape of a cross-section of the inlet channel and a shape of a cross-section of the outlet channel along the first plane, the dust filter thus being arranged such that, when it is installed in the meter, such that the first plane coincides with the second plane, the gas, before entering into the measuring module, passes into the inlet channel through the filtering medium, and after exiting from the measuring module, passes into the outlet channel through the hole.

The dust filter makes it possible to filter the dust present in the gas before this enters into the measuring module. The shape of the filter, which is adapted both to the cross-section of the inlet channel and the cross-section of the outlet channel, makes it possible to integrate in the proximity of the gas inlet/outlet in the meter, and therefore at a distance from the measuring module. The dust particles are therefore trapped at a zone away from the inlet of the measuring module. The entering of dust into the measuring module is thus limited to the maximum, which makes it possible to guarantee stable metrological performance over time.

Optionally, the hole is positioned in a central portion of the filtering medium.

Optionally, the filter comprises at least one first generally flat frame, which is positioned against a first face of the filtering medium by being fixed to it.

Optionally, a contour of the first frame has one same shape as a contour of the filtering medium, a width and a length of the filtering medium being greater than a width and a length of the first frame.

Optionally, the first face is a lower face of the filtering medium when the dust filter is installed in the meter, the dust filter further comprising a magnet positioned on the first frame and arranged to attract metal dust particles.

Optionally, the filter comprises at least one first pressure sensor which is positioned on the first frame.

Optionally, the filter comprises a second generally flat frame, which is positioned against a second face of the filtering medium by being fixed to it, the dust filter further comprising at least one second pressure sensor which is positioned on the second frame.

Optionally, the filtering medium has a generally flat shape and has, when it is seen from above or below, a square or rectangular shape having rounded corners.

Optionally, the first frame is made of polyoxymethylene.

Optionally, the filtering medium is a polyester medium. The invention also relates to a single-tube gas meter comprising a measuring module arranged to measure a flow rate of a gas, as well as an inlet channel which extends upstream from the measuring module and an outlet channel which extends downstream from the measuring module, the inlet channel and the outlet channel passing through one same first plane, the meter further comprising a dust filter such as mentioned above, the dust filter being installed in the meter, such that the first plane coincides with the second plane.

Optionally, the first plane is a horizontal plane.

Optionally, the meter comprises a tank comprising a first chamber and a second chamber, the first chamber being an upper chamber and the second chamber being a lower chamber, when the meter is installed in a nominal position, the meter comprising in addition a connecting device comprising a gas inlet and a gas outlet, the gas inlet opening into the first chamber, the measuring module being located in the second chamber, the dust filter separating the first chamber and the second chamber.

Optionally, the meter comprises a fixing nozzle arranged to hold the dust filter in position, the meter comprising in addition a connecting conduit which fluidically connects the first chamber to the second chamber, the dust filter being installed such that the connecting conduit extends through the hole, the fixing nozzle being inserted into the connecting conduit and comprising at least one seal arranged to avoid the non-filtered gas passing from the first chamber to the second chamber through a path located between the fixing nozzle and the connecting conduit.

Optionally, the meter further comprises a gas mixing enclosure, the connecting conduit being an outlet conduit of the gas mixing enclosure.

Optionally, the measuring module comprises a measuring conduit wherein the gas circulates, the measuring conduit being positioned vertically when the meter is installed in its nominal position.

Optionally, the measuring module comprises a measuring conduit wherein the gas circulates, the meter comprising in addition an additional conduit, having a shape and dimensions similar to those of the measuring conduit, and being disposed parallel to the measuring conduit, the additional conduit being arranged such that a portion of the gas which circulates in the second chamber to the gas outlet, passes through the additional conduit, which makes it possible to reduce a flow rate of gas circulating in the measuring conduit.

Optionally, the measuring conduit and the additional conduit open into the gas mixing enclosure.

Optionally, the meter comprises an dust filter, the meter comprising a processing unit arranged to compare, with a reference threshold, a pressure difference between a first pressure measurement produced by the first pressure sensor and a second pressure measurement produced by the second pressure sensor, and to produce an alarm message if the pressure difference is greater than said reference threshold.

The invention will be best understood in the light of the description below of particular, non-limiting embodiments of the invention.

### BRIEF DESCRIPTION OF THE DRAWINGS

Reference will be made to the accompanying drawings, among which:

FIG. 1 is a cross-sectional view, along a vertical plane, of a single-tube gas meter integrating the dust filter according to a first embodiment;

FIG. 2 is a view similar to FIG. 1, but simplified, wherein only the filter, the fixing nozzle, the mixing enclosure, the measuring module and the additional conduit are represented;

FIG. 3 is a perspective and top view of the filter;

FIG. 4 is a perspective and top view of the filter prior to its assembly;

FIG. 5 is a graph comprising curves of the measuring error according to the flow rate of the gas;

FIG. 6 is a perspective and bottom view of the dust filter according to a second embodiment;

FIG. 7 is a perspective and top view of the dust filter according to a third embodiment;

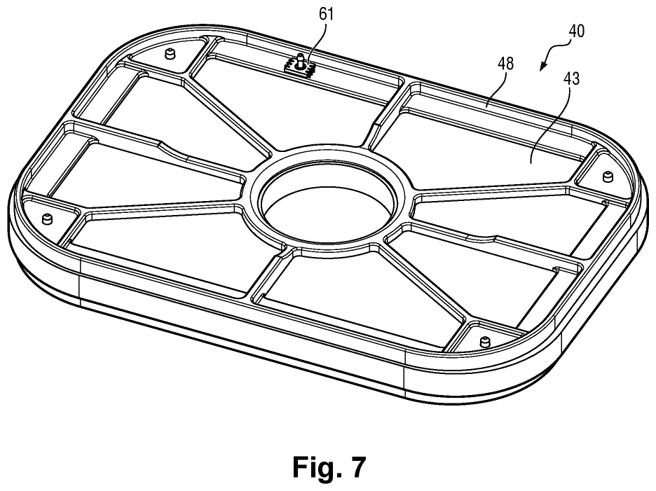

FIG. 8 is a figure similar to FIG. 1, with the dust filter according to the third embodiment.

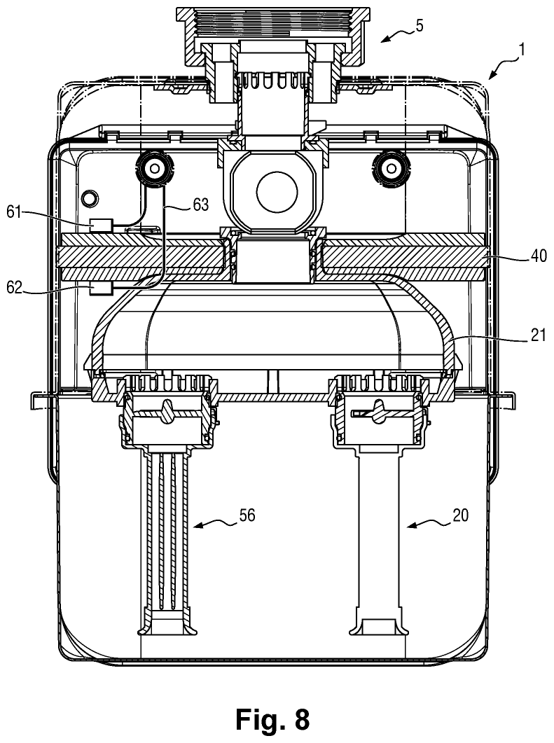

### DETAILED DESCRIPTION OF THE INVENTION

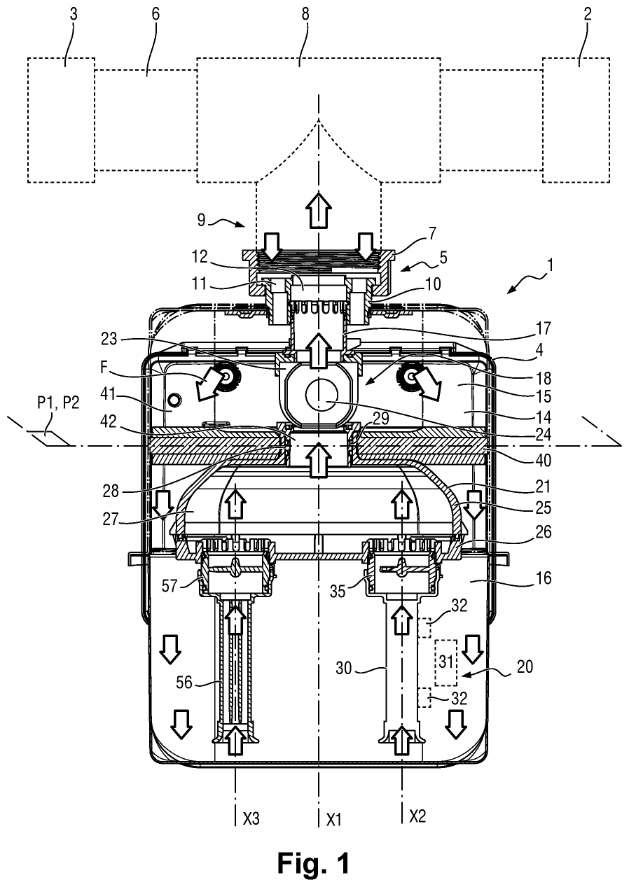

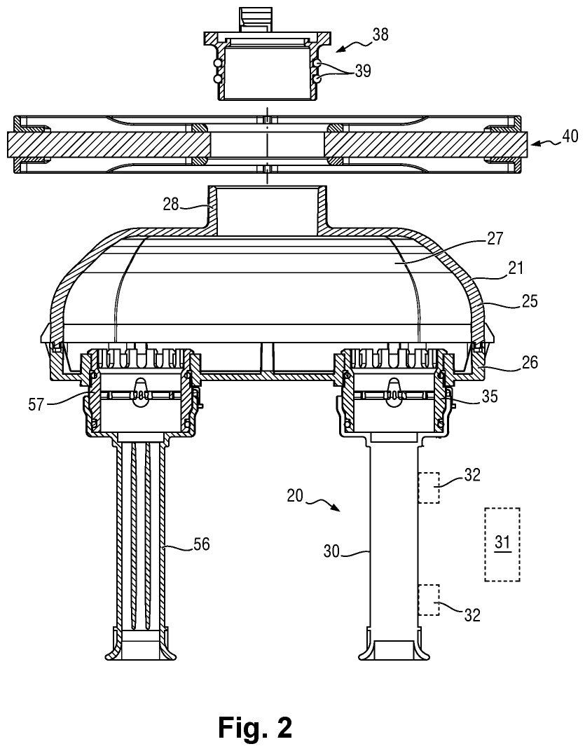

In reference to FIGS. 1 and 2, the meter 1 is an ultrasonic, single-tube “smart” gas meter (smart meter). The meter 1 is used to measure the gas consumption of an installation 2. The gas is supplied to the installation by a distribution network 3.

The meter 1 comprises a casing 4 which comprises a connecting device 5. The connecting device 5 makes it possible to connect a pipe 6 to the meter 1, which connects the distribution network 3 to the installation 2.

The connecting device 5 comprises a female threaded connector 7.

A (T-shaped) connector 8 connects two portions of the pipe 6 together. The connector 8 comprises a port 9 which comprises a male threaded connector (not represented).

The connector 8 is connected to the meter 1 via its port 9 and via the connecting device 5 of the meter 1.

The connecting device 5 in addition comprises connecting nozzle 10 fixed to the connector 7. The connecting nozzle 10 comprises a gas inlet, comprising three inlet orifices 11 which are slots forming circular angular portions which extend to the proximity of a circumference of the connecting nozzle 10, and a gas outlet, comprising an outlet orifice 12, which is positioned at the centre of the connecting nozzle 10.

The gas enters into the meter 1 via the inlet orifices 11, and exits via the outlet orifice 12. The pathway of the gas is indicated by the arrows F in FIG. 1.

The position of the meter 1 represented in FIGS. 1 and 2 is the nominal position of the meter 1, i.e. the operating position that it occupies when it is switched on and positioned correctly. The connecting device 5 is therefore positioned at an upper part of the casing 4 of the meter 1. In this text, each time that a positioning term relating to an object is used (upper, lower, etc.), the nominal position of this object is referred to, switched on.

A tank 14 is defined inside the casing 4 of the meter 1. The tank 14 comprises a first (upper) chamber 15 and a second (lower) chamber 16.

The gas inlet, i.e. the inlet orifices 11 of the connecting nozzle 10 of the connecting device 5, therefore opens into the first chamber 15.

The meter 1 in addition comprises a connecting nozzle 17, located in the first chamber 15.

The meter 1 optionally comprises an electromechanical valve 18 also located in the first chamber 15. The electromechanical valve 18 (optional as indicated above) is a ball valve which comprises a conduit 23 and a ball 24 positioned in the conduit 23. The angular position of the ball 24 can be remotely controlled, which makes it possible to cut, limit or reestablish the gas flow rate supplied to the installation 2.

The meter 1 further comprises a measuring module 20 and a gas mixing enclosure 21, which are located in the second chamber 16.

The connecting nozzle 17 has an end inserted into an end of the conduit 23, and another end which is fixed by elastic interlocking to the connecting nozzle 10, such that the outlet orifice 12 of the connecting nozzle 10 is in fluid communication with the conduit 23 of the valve 18 via the connecting nozzle 17.

The enclosure 21 comprises a bell-shaped upper portion 25, and a lower portion which forms a horizontal base 26 of the enclosure 21. A mixing chamber 27 is defined inside the upper portion 25. The upper portion 25 and the horizontal base 26 are fixed to one another by elastic interlocking. The upper portion 25 of the enclosure 21 comprises an outlet conduit 28, which is connected to the conduit 23 of the valve 18.

The connector 7, the connecting nozzle 10 (of the connecting device 5), the connecting nozzle 17, the valve 18, the outlet conduit 28, the mixing chamber 27 and the base 26 (of the enclosure 21), are positioned successively, from top to bottom, along a vertical axis X1.

The measuring module 20 comprises a measuring conduit 30, a processing unit 31 and two ultrasonic transducers 32 (schematically represented in FIGS. 1 and 2 and in positions not representative of reality).

The processing unit 31 is located outside of the tank 14. It is integrated in an electronic board of the meter 1, which is not necessarily only dedicated to the flow rate measurement. The processing unit 31 comprises at least one processing component (electronic and/or software), which is, for example, a “general” processor, a processor specialising in signal processing (or DSP, Digital Signal Processor), a microcontroller, or a programmable logic circuit, such as an FPGA (Field Programmable Gate Arrays) or an ASIC (Application Specific Integrated Circuit). The processing unit 31 also comprises an excitation signal generator, and a signal receiver.

The measuring module 20 operates as follows. Each ultrasonic transducer 32 successively plays the role of an emitter and a receiver. The processing unit 31 generates an electric excitation signal and applies it to the terminals of an emitting transducer. The emitter emits an ultrasonic signal into the measuring conduit 30, which is captured by the receiver after having travelled a path of predefined length in the measuring conduit 30. Then, the receiving transducer itself becomes an emitter and emits an ultrasonic signal, which is captured by the other transducer, after having travelled the same path, in the opposite direction.

The processing unit 31 deduces the speed of the gas and therefore the flow rate of the gas from the signals received.

The measuring conduit 30 comprises, at its outlet end of the gas, a fixing nozzle 35 which is fixed by elastic interlocking to the base 26 of the envelope 21. The measuring conduit outlet 30 therefore opens into the mixing chamber 27 via the fixing nozzle 35.

The measuring conduit 30 is positioned vertically. Its longitudinal axis X2 is parallel to the axis X1, without being combined with it.

The first chamber 15 and the second chamber 16 are separated by a dust filter 40.

The first chamber 15 and the second chamber 16 are in fluid communication via the filter 40 and via a connecting conduit, which is the outlet conduit 28 of the gas mixing enclosure 21.

The pathway of the gas in the meter 1 is as follows. The gas enters into the meter 1 via the inlet orifices 11 of the connecting nozzle 10 of the connecting device 5 and therefore enters into the first chamber 15.

It crosses the dust filter 40 then enters into the second chamber 16. It thus passes through the measuring conduit 30 of the measuring module 20, and enters into the mixing chamber 27, where it is mixed again, such that it exits from the mixing chamber 27 by being homogeneous. It thus passes through the outlet conduit 28 of the envelope 21, through the conduit 23 of the valve 18, through the connecting nozzle 17, then through the outlet orifice 12 of the connecting nozzle 10 of the connecting device 5 of the meter 1.

The meter 1 comprises an inlet channel 41, which extends upstream from the measuring module 20 and through which the gas passes before entering into the measuring conduit 30, and an outlet channel 42, which extends downstream from the measuring module 20 and through which the gas passes after exiting from the measuring conduit 30. In this case, the terms “upstream” and “downstream” are defined with respect to the direction of circulation of the gas in the meter 1.

The inlet channel 41 and the outlet channel 42 pass through one same first plane P1. The first plane P1 is, in this case, a horizontal plane, which is perpendicular to a direction of circulation of the gas in the meter 1.

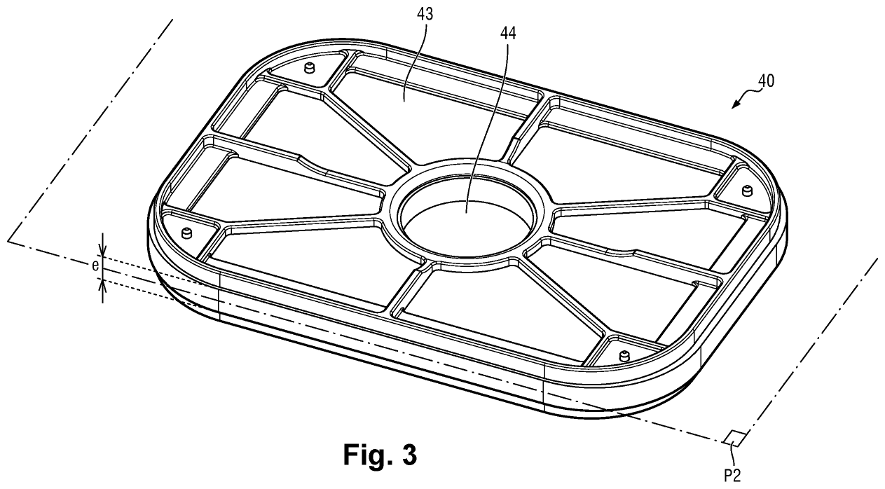

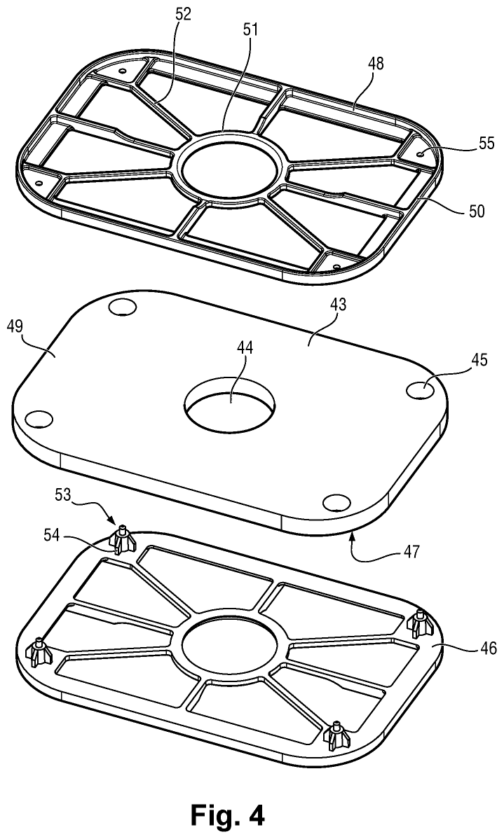

In reference to FIGS. 3 and 4, the dust filter 40 comprises a filtering medium 43, wherein a main hole 44 is made.

The filtering medium 43, in this case, has a generally flat shape. Through this term, this means that its thickness is clearly less than its length and its width (for example, at least 5 times less).

A cross-section of the filtering medium 43 and a cross-section of the main hole 44, along a second plane P2 perpendicular to a thickness e of the filtering medium 43, respectively have as shapes, a shape of a cross-section of the inlet channel 41 and a shape of a cross-section of the outlet channel 42 along the first plane P1.

The dust filter 40 is thus arranged such that, when it is installed in the meter 1, such that the first plane P1 coincides with the second plane P2, the gas, before entering into the measuring conduit 30 of the measuring module 20, passes into the inlet channel 41 through the filtering medium 43, and after exiting from the measuring conduit 30 of the measuring module 20, passes into the outlet channel 42 through the main hole 44.

The cross-section of the inlet channel is, in this case, the cross-section of the first chamber 15. The cross-section of the outlet channel 42 is, in this case, the cross-section of the outlet conduit 28 of the envelope 21.

It is noted that the meter 1 in addition comprises a cylindrical-shaped fixing nozzle 38 which is inserted in the outlet conduit of the envelope 21. The fixing nozzle 38 makes it possible to hold the filter 40 in position in the meter 1. Two seals 39 (in this case, of the O-ring type) are positioned in the recesses made on the fixing nozzle 38.

At the time of assembling the meter 1, the filter 40 is positioned such that the outlet conduit 28 extends through the main hole 44 of the filter 40. The filter 40 is thus placed on the upper portion 25 of the enclosure 21. The fixing nozzle 38 is thus inserted in the outlet conduit 28. The fixing nozzle 38 comprises an enlarged end which bears against the filter 40, such that this is held immobile between the enlarged end of the fixing nozzle 38 and the upper portion 25 of the enclosure 21.

The seals 39 of the fixing nozzle 38 make it possible to make the interface sealed between the fixing nozzle 38 and the outlet conduit 28, which makes it possible to guarantee a separation between the entering gas and the exiting gas, and to avoid the non-filtered gas passing from the first chamber 15 to the second chamber 16 through a path located between the fixing nozzle 38 and the outlet conduit 28.

The filtering medium 43, when it is seen from above or below, has a square or rectangular shape (in this case, rectangular) with rounded corners.

The main hole 44 is positioned at a central portion of the filtering medium. In this case, the centre of the hole 44 is at the centre of the filtering medium 43.

The filtering medium 43 in addition comprises four fixing holes 45, each being positioned in one of the corners of the filtering medium 43.

The filter 40 further comprises at least one first generally flat frame 46, which is positioned against a first face 47 of the filtering medium 43 by being fixed to it. The filter 40 in addition comprises, in this case, a second generally flat frame 48, which is positioned against a second face 49 of the filtering medium 43 by being fixed to it.

In this case, when the filter 40 is installed in the meter 1, the first face 47 of the filtering medium 43 is a lower face and the second face 49 is an upper face. The filtering medium 43, the first frame 46 and the second frame 48 thus form, when the filter 40 is assembled, three “sandwiched” layers, the filtering medium 43 being positioned between the first frame 46 and the second frame 48.

Each frame 46, 48 comprises a border 50, a circular-shaped central portion 51, and branches 52 which connect the border 50 to the central portion 51. The remaining surface of each frame 46, 48 is hollowed. The recess increases the filtering surface through which the gas passes, and therefore the effectiveness of the filtering.

Just like the filtering medium 43, the border 50 of each frame has the shape of a rectangle with rounded corners. The edges of the border are hollowed in their thickness.

The border 50 of each frame 46, 48 has the same shape as the contour of the filtering medium 43, but the width and the length of the filtering medium 43 are slightly greater than those of said border, typically from 1 to 5 mm.

When the filter 40 is assembled, the central portion 51 of each frame 46, 48 coincides approximately with the circumference of the main hole 44 of the filtering medium 43, but the main hole 44 has a diameter slightly less than that of each central portion 51, typically from 1 to 5 mm.

Each frame 46, 48 comprises eight branches 52: four branches 52 connect the four corners of the border 50 to the central portion 51 (in each corner, the angle between a branch 52 and each edge forming the corner is equal to 45°), and four branches 52 connect the middles of the four edges of the frame to the central portion 51 (each of these branches extending perpendicularly from the edge in question).

The portions of the edges of the border 50, located between the corners and the points from where the branches 52 extend, are hollowed in their thickness.

The first frame 46 comprises four pins 53 located in the corners of the border 50 of said first frame 46. The free end of each pin 53 is slightly enlarged. Each pin 53 comprises radial fins 54 having a free end inclined towards the free end of the pin 53.

The second frame 48 comprises four holes 55 located in the corners of said second frame 48.

The filter 40 is assembled as follows. The first frame 46 is positioned against the first face 47 of the filtering medium 3, such that the pins 53 pass into the fixing holes 45 of the filtering medium 43. The shape of the fins 54 facilitates the insertion and the passage of the pins 53. Then, the second frame 48 is positioned against the second face 49 of the filtering medium 43. The pins 53 of the first frame 46 enter into the holes 55 of the second frame. The insertion of the enlarged ends of the pins 53 into the holes 55 makes it possible to fix the first frame 46 and the second frame together by elastic interlocking.

The frames 46, 48 make it possible to rigidify the filter 40 and to avoid the filtering medium 43 crinkling or forming cavities under the effect of the gas which passes through it.

The assembly of the filter 40, using the pins 53 and the holes 45, 55, is easy, rapid, and requires no complex assembly machine.

The dimensions (width and length) of the frames 46, 48 are normally equal to those of the cross-section of the first chamber 15 of the meter 1 along the plane P1 (with a close mounting clearance), such that when the filter 40 is positioned in the meter 1, the borders 50 of the frames 46, 48 are in contact with the internal walls of the tank 14 of the meter (with a closing mounting clearance).

The fact that the dimensions of the filtering medium 43 by length and by width are slightly greater than those of the frames 46, 48 makes it possible to compensate for the mechanical tolerances which could create passages for the dust. The filtering medium 43 is compressed against the internal walls of the tank 14, which forms a seal preventing any passage of gas between the walls of the tank 14 and the filter 40.

Likewise, the fact that the main hole 44 has a diameter slightly less than that of each central portion 51 makes it possible to compress the filtering medium against the outlet conduit 28, which forms a seal preventing any passage of gas between the outlet conduit 28 and the filter 40.

The frames 46, 48 are, in this case, made of polyoxymethylene (or “POM”), which is a semi-crystalline thermoplastic. Other types of plastic could be used, but POM has several advantages which make it perfectly suitable for use in a gas meter. POM has, for example:
a good dimensional stability according to the temperature;
a good resistance to aggressive chemical products (for example, to ammoniac and to sulphur);
a high resistance to fatigue and to wear;
a moulding facility: POM is easy to mould, which makes it an ideal material for precision mechanical parts.

Now, the choice of the material forming the filtering medium 43 is studied.

The filtering medium 43 is, in this case, a synthetic medium filter.

The advantages of the synthetic medium filter are:
a great resistance to abrasion and to tearing;
a high capacity to retain particles, which can be adjusted according to specific needs;
it can be used under extreme temperature and pressure conditions;
it has a low resistance to air, which enables a high air flow rate and a low load loss;
this type of filtering medium is resistant to most chemical products and corrosive agents.

Naturally, the performance of the filtering medium 43 will depend on several parameters, like:
its thickness: from a few mm to a few cm;
the pore size: it is important to choose a filter with a sufficiently small pore size to retain the metal dust particles. The filtering medium has, in this case, pores of a size smaller than the size of the particles to be filtered, i.e. of a size less than 400 μm (the diameter of the metal dust particles present in the gas varies between 0.1 μm and 400 μm);
the retention of particles: it is also important to choose a filter having a high capacity to retain particles to effectively retain the metal dust (example: 400 g/m2);
the load loss according to the flow rate: it is important to choose a filter having a low resistance to air to avoid gas pressure drops in the final consumer (example: 0.0002 mbar/m3).

The filtering medium chosen is, in this case, a synthetic filtering medium having the following features:
thickness: 8 mm;
composition: polyester fibres 100;
class: G3 aor G4;
dust retention capacity: 400 g/m2;
thermal stability: 100° C.;
initial load loss: 0.0002 bar/m3.

Class G3 is a European standard used to classify air filters according to their filtering capacity. It indicates that the filter has a minimum filtering effectiveness of 50% for particles from 0.3 and 1 micron. This means that if 100% of the particles of this size are present in the air, at least 50% will be retained by the filter.

Class G4 is a European standard used to classify air filters according to their filtering capacity. It indicates that the filter has a minimum filtering effectiveness of 85% for particles from 0.3 and 1 micron. This means that if 100% of the particles of this size are present in the air, at least 85% will be retained by the filter.

Now, the evaluation of the performance of the filter 40 which has been described and its integration in the gas meter 1 are studied.

As has been seen, the main disadvantage of the presence of dust is the degradation of the accuracy of measuring the gas flow rate.

A normative dust resistance test has been carried out in a certified laboratory to evaluate the performance of the filter 40. This test consists of measuring the accuracy of the meter 1 in the presence of 20 grammes of dust (normative requirement).

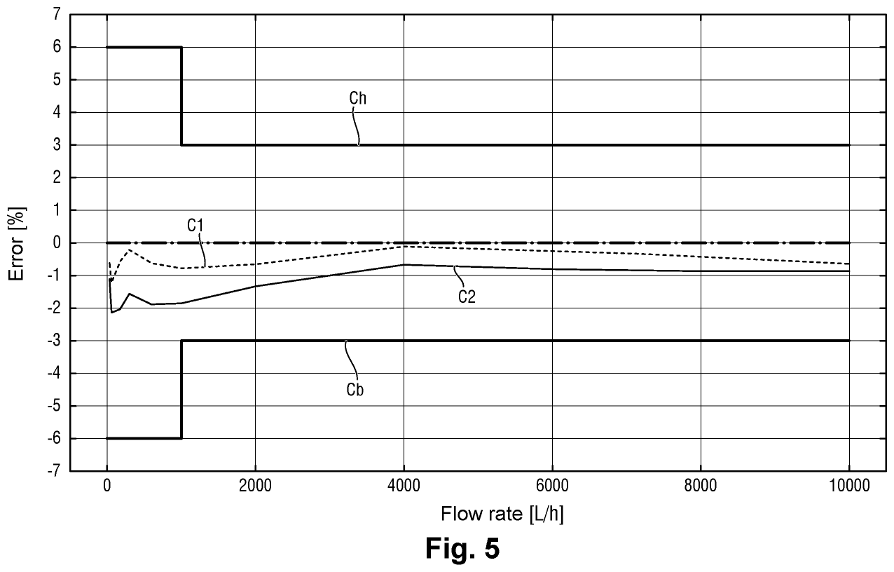

The results obtained can be seen in FIG. 5.

For the test to be successful, the curve of the error according to the flow rate must remain inside a metrological gauge defined by the high limit curve Ch and a low limit curve Cb.

The curve C1 represents the evolution of the error according to the flow rate before the normative dust resistance test, i.e. before the introduction of the dust.

The curve C2 represents the evolution of the error according to the flow rate after the introduction of the dust. It is seen that the accuracy has been slightly degraded by the test. The metrological error is degraded on average by 0.7%, but remains in the metrological gauge and therefore complies with the standard.

It has also been verified that the presence of the filter 40 does not cause an unacceptable load loss.

Indeed, according to standard EN 14236, the meter must have a load loss less than 2 mbar at the maximum flow rate. Standard EN 14236 is a European standard which defines the requirements for ultrasonic gas meters. It covers the performance requirements, the safety requirements, the reliability requirements the electromagnetic and compatibility requirements for ultrasonic gas meters. The performance requirements include the measuring accuracy, the measuring stability, the operating temperature, the operating pressure, the electromagnetic compatibility, the resistance to dust, and the safety requirements include the requirements linked to electrical safety and fire safety.

It is reminded that G6-type meters have a minimum flow rate of 0.06 m³/h and a maximum flow rate of 10 m³/h. G4-type meters have a minimum flow rate of 0.04 m³/h and a maximum flow rate of 6 m³/h. G6 meters adapted for gas consumptions which are higher than G4 meters.

The load loss can increase after the “dust resistance” normative test, but it must remain less than 2.2 mbar to the maximum flow rate.

The reference load loss at Qmax (maximum flow rate) is: 1.1 mbar.

The load loss after the “dust resistance” test at Qmax (maximum flow rate) is: 1.15 mbar.

It is noted that the difference between the two load losses is negligible which proves that the concept is validated and that the filter 40 is not clogged.

FIGS. 1 and 2 are returned to. It is seen that the meter 1 comprises an additional conduit 56. The additional conduit 56 is a geometric copy of the measuring conduit 30 of the measuring module 20: it has a shape and dimensions similar to those of the measuring conduit 30, but it is not equipped with electronics to take measurements.

The additional conduit 56 also comprises a fixing nozzle 57 (similar to the nozzle 35) which is fixed by elastic interlocking to the base 26 of the mixing enclosure 21, such that the outlet of the additional conduit 56 opens into the mixing chamber 27.

The additional conduit 56 is disposed parallel to the measuring conduit 30: its longitudinal axis X3 is parallel to the axis X1, without being combined with it. The axes X1, X2, X3 are parallel, and the axes X2 and X3 are located on either side of the axis X1 at an equal distance from it.

The additional conduit 56 is thus arranged, such that a portion of the gas which circulates in the second chamber 16 to the gas outlet, passes through the additional conduit 56, which makes it possible to reduce a flow rate of gas circulating in the measuring conduit 30 of the measuring module 20.

The volume which passes into the measuring conduit 30 is identical (normally) to the volume which passes through the additional conduit 56 (as same geometry, same hydraulic of the conduits). The total volume of gas passing through the meter 1 is therefore equal to double the volume passing through the measuring conduit 30 of the measuring module 20. This system makes it possible to avoid the saturation of the measurements of the measuring module 20 by dividing the flow rate passing through it by two. Thus, the measuring dynamic is multiplied by two.

It is noted that it would be possible to use, not one, but several additional conduits 56, to copy the measuring conduit 30 several times, which makes it possible to divide the flow rate more significantly.

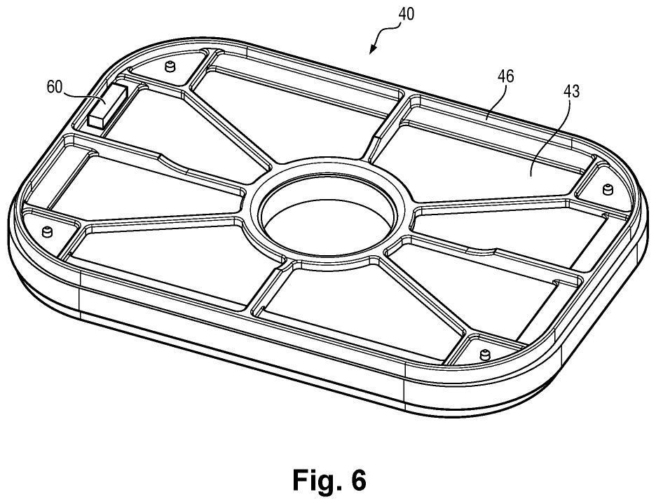

In a second embodiment, in reference to FIG. 6, the filter 40 comprises one or more magnets.

In this case, the filter 40 comprises one single magnet 60 which is positioned on the first frame 46, by being adhered to an external face of it (which does not face the filtering medium 43), i.e. to the face directed downwards, when the filter 40 is installed in the meter. Any fixing means can be used to fix the magnet (s) 60 to the frame (s).

Adding one or more magnets 60 on the first frame 46 increases the performance of the filter by increasing the retaining force of the dust particles. The magnets 60 create a magnetic field which attracts the metal dust particles, such as iron particles (knowing that 92% of the dust used for the certification tests in a gas meter are iron particles).

These dust particles are thus trapped by the filter 40, which increases its filtering effectiveness. The magnet (s) 60 can also assist with decreasing the load loss due to the accumulation of dust particles on the filter 40, which can also improve the performance of the filter 40.

In a third embodiment, the filter 40 comprises at least one pressure sensor which measures a pressure of the gas in the tank 14 of the meter 1.

In this case, the filter 40 is equipped with two pressure sensors 61, 62 which are fixed to the frames, for example by adhering (or by any other fixing means). The first pressure sensor 61 is positioned on the lower face (external face) of the first frame 46. The second pressure sensor 62 is positioned on the upper face (external face) of the second frame 48.

In view of the low pressure to be measured, in this case, for example, pressure sensors of the MEMS type, and for example, the “MCD70D” model are used, which has the following features:
pressure range: 0 to 68.9 mbar;
supply voltage: 3 to 5.5 Volts;
outlet: analogue or bus I2C;
precision: +2% of full scale;
humidity: <95%;
operating temperature: −20 to 70° C.

The pressure sensors 61, 62 are connected to the processing unit 31 of the meter 1 (which is located outside of the tank 14).

The pressure sensors 61, 62 make it possible to measure the evolution of the load loss.

During the calibration of the meter 1, at the end of its manufacture, a first pressure measurement P1 is acquired, taken by the first pressure sensor 61 and a second pressure measurement P2 taken by the second pressure sensor 62 and this, for several flow rate values. Thus, the corresponding load loss (ΔP: P1-P2) for each flow rate value is calculated.

These load loss values ΔP will be used as a reference to be able to monitor the evolution of the load loss during the life of the meter 1.

As an example, the reference load loss ΔP0 at 10000 l/h, measured during the calibration of the meter 1 is, for example, equal to 1 mbar.

If the filter clogs over time, this load loss will therefore increase and risk exceeding a reference threshold (example: ΔP=2 mbar).

This information can be used to alert the client about the quality of their network and on the risk of clogging and of pressure drop in the meter 1.

The processing unit 31 compares, with a reference threshold, a pressure difference between a first pressure measurement produced by the first pressure sensor 61 and a second pressure measurement produced by the second pressure sensor 62, and produces an alarm message if the pressure difference is greater than said reference threshold.

The wires 63 make it possible to connect the pressure sensors 61, 62 to the processing unit 31.

Naturally, the invention is not limited to the embodiments described, but comprises any variant entering into the field of the invention such as defined by the claims.

The filter could be positioned differently in the meter. The plane P1 is not necessarily a horizontal plane. The portion of the outlet channel which extends through the main hole is not necessarily the outlet conduit of a mixing enclosure.

The shape of the filter could be different. The filter could comprise one single frame. The materials used for the filtering medium and the frames can be different from those described, in this case. The filter could comprise both one or more magnets and one or more pressure sensors.

1. A dust filter, arranged to be installed in a single-tube gas meter which comprises a measuring module arranged to measure a flow rate of a gas, as well as an inlet channel which extends upstream from the measuring module and an outlet channel which extends downstream from the measuring module, the inlet channel and the outlet channel passing through one same first plane,
the dust filter comprising a filtering medium wherein a hole is made, a cross-section of the filtering medium and a cross-section of the hole, along a second plane perpendicular to a thickness of the filtering medium, respectively having for shapes, a shape of a cross-section of the inlet channel and a shape of a cross-section of the outlet channel along the first plane,
the dust filter thus being arranged such that, when it is installed in the meter, such that the first plane coincides with the second plane, the gas, before entering into the measuring module, passes into the inlet channel through the filtering medium, and after exiting from the measuring module, passes into the outlet channel through the hole,
the dust filter further comprising at least one generally flat first frame, which is positioned against a first face of the filtering medium by being fixed to it,
the first face being a lower face of the filtering medium when the dust filter is installed in the meter, the dust filter further comprising a magnet positioned on the first frame and arranged to attract metal dust particles.

2. The dust filter according to claim 1, wherein the hole is positioned in a central portion of the filtering medium.

3. The dust filter according to claim 1, wherein a contour of the first frame has one same shape as a contour of the filtering medium, a width and a length of the filtering medium being greater than a width and a length of the first frame.

4. The dust filter according to claim 1, comprising at least one first pressure sensor which is positioned on the first frame.

5. The dust filter according to claim 4, further comprising a second generally flat frame, which is positioned against a second face of the filtering medium by being fixed to it, the dust filter further comprising at least one second pressure sensor which is positioned on the second frame.

6. The dust filter according to claim 1, the filtering medium having a generally flat shape and has, when it is seen from above or below, a square or rectangular shape having rounded corners.

7. The dust filter according to claim 1, the first frame being made of polyoxymethylene.

8. The dust filter according to claim 1, the filtering medium being a polyester medium.

9. A single-tube gas meter comprising a measuring module arranged to measure a flow rate of a gas, as well as an inlet channel which extends upstream from the measuring module and an outlet channel which extends downstream from the measuring module, the inlet channel and the outlet channel passing through one same first plane, the meter further comprising a dust filter according to one of the preceding claims, the dust filter being installed in the meter, such that the first plane coincides with the second plane.

10. The meter according to claim 9, the first plane being a horizontal plane.

11. The meter according to claim 9, the meter comprising a tank comprising a first chamber and a second chamber, the first chamber being an upper chamber and the second chamber being a lower chamber when the meter is installed in a nominal position, the meter in addition comprising a connecting device comprising a gas inlet and a gas outlet, the gas inlet opening into the first chamber, the measuring module being located in the second chamber, the dust filter separating the first chamber and the second chamber.

12. The meter according to claim 11, further comprising a fixing nozzle arranged to hold the dust filter in position, the meter in addition comprising a connecting conduit which fluidically connects the first chamber to the second chamber, the dust filter being installed such that the connecting conduit extends through the hole, the fixing nozzle being inserted into the connecting conduit and comprising at least one seal arranged to avoid the non-filtered gas passing from the first chamber to the second chamber through a path located between the fixing nozzle and the connecting conduit.

13. The meter according to claim 12, the meter further comprising a gas mixing enclosure, the connecting conduit being an outlet conduit of the gas mixing enclosure.

14. The meter according to claim 9, wherein the measuring module comprises a measuring conduit, wherein the gas circulates, the measuring conduit being positioned vertically when the meter is installed in its nominal position.

15. The meter according to claim 9, wherein the measuring module comprises a measuring conduit wherein the gas circulates, the meter in addition comprising an additional conduit, having a shape and dimensions similar to those of the measuring conduit, and being disposed parallel to the measuring conduit, the additional conduit being arranged such that a portion of the gas which circulates in the second chamber to the gas outlet, passes through the additional conduit, which makes it possible to reduce a flow rate of gas circulating in the measuring conduit.

16. The meter according to claim 13, wherein the measuring conduit and the additional conduit open into the gas mixing enclosure.

17. The meter according to claim 9, comprising a dust filter, wherein the dust filter is arranged to be installed in a single-tube gas meter which comprises a measuring module arranged to measure a flow rate of a gas, as well as an inlet channel which extends upstream from the measuring module and an outlet channel which extends downstream from the measuring module, the inlet channel and the outlet channel passing through one same first plane,
the dust filter comprising a filtering medium wherein a hole is made, a cross-section of the filtering medium and a cross-section of the hole, along a second plane perpendicular to a thickness of the filtering medium, respectively having for shapes, a shape of a cross-section of the inlet channel and a shape of a cross-section of the outlet channel along the first plane,
the dust filter thus being arranged such that, when it is installed in the meter, such that the first plane coincides with the second plane, the gas, before entering into the measuring module, passes into the inlet channel through the filtering medium, and after exiting from the measuring module, passes into the outlet channel through the hole,
the dust filter further comprising at least one generally flat first frame, which is positioned against a first face of the filtering medium by being fixed to it,
the first face being a lower face of the filtering medium when the dust filter is installed in the meter, the dust filter further comprising a magnet positioned on the first frame and arranged to attract metal dust particles, and
the first frame being made of polyoxymethylene,
the meter comprising a processing unit arranged to compare, with a reference threshold, a pressure difference between a first pressure measurement produced by the first pressure sensor and a second pressure measurement produced by the second pressure sensor, and to produce an alarm message if the pressure difference is greater than said reference threshold.
